(19) United States
(12) Patent Application Publication
(10) Pub. No.: US 2022/0003640 A1
(43) Pub. Date: Jan. 6, 2022

(54) SUPPORT BACKING STRIP TECHNOLOGY AND METHOD FOR NON-DESTRUCTIVE IDENTIFICATION OF LATENT PRINT AND DNA DEPOSITED ON ADHESIVE MATERIALS

(71) Applicant: Signature Science, LLC, Austin, TX (US)

(72) Inventors: F. Curt Hewitt, Austin, TX (US); Kathleen Q. Schulte, Cedar Park, TX (US)

(21) Appl. No.: 16/919,095

(22) Filed: Jul. 1, 2020

(51) Int. Cl. G01N 1/28; G01N 1/40

(52) U.S. Cl. CPC G01N 1/2813; G01N 2001/4061; G01N 2001/2833; G01N 1/4055

(57) ABSTRACT

A method is provided for recovering a sample of DNA. The method includes providing a portion of adhesive tape having first and second opposing major surfaces, wherein said first major surface has an adhesive disposed thereon; applying a backing strip to the second major surface of the tape, thereby obtaining a mounted tape, wherein said backing strip has first and second opposing major surfaces, and wherein said first and second major surfaces of said backing strip are embossed; capturing a fingerprint on the first surface of the mounted tape, thereby obtaining a specimen, wherein said specimen contains DNA; winding the specimen into a helical configuration in which opposing surfaces of the adhesive tape are spaced apart from each other by said backing strip, thereby obtaining a wound specimen; placing the wound specimen in a receptacle; and extracting a sample of DNA from the wound specimen with a solvent.

### CROSS-REFERENCE TO RELATED APPLICATIONS

The present application claims the benefit of priority from U.S. Provisional Application No. 62/863,175, filed on Jun. 18, 2019, which has the same title and the same inventors, and which is incorporated herein by reference in its entirety.

### FIELD OF THE DISCLOSURE

The present disclosure relates generally to non-destructive methods for latent fingerprint visualization and the recovery of DNA materials from adhesive tape for forensic or other evidentiary analysis.

### BACKGROUND OF THE DISCLOSURE

Latent fingerprints are created when a person touches an object and the sweat and oils at the ridges and valleys of the person's fingertips are deposited onto a surface of the object in a reverse-pattern that is unique and traceable to every individual. Latent fingerprints (LPs), and the deoxyribonucleic acid (DNA) extractable from them, can be used for identification and evidentiary purposes during forensic investigations. Current state of the art techniques for processing fingerprints include the “lifting” of latent fingerprints left behind at crime scenes as forensic evidence. At present, this type of forensic evidence is widely accepted in courts of law.

Current methods for lifting latent fingerprints from adhesive substrates require the loss of the evidence itself (e.g., the adhesive tape) as well as the print from which the DNA is isolated for “touch DNA.” Touch DNA is DNA that is transferred via skin cells when an object is handled or touched, and touch DNA forensic methods are used for collecting and analyzing DNA left by latent fingerprints.

Currently known techniques for collecting forensic evidence include the capture of latent fingerprints at crime scenes or elsewhere. Unfortunately, current best practices often render evidence which is potentially unusable upon latent print or subsequent DNA analysis.

Touch samples deposited onto adhesive surfaces (such as adhesive tape) may be extremely useful evidentiary items. However, such samples pose a significant challenge for forensic casework laboratories. These limitations exist whether the tape itself comprises the evidence (e.g., latent fingerprints and DNA from electrical tape associated with an explosive device) or whether the tape was used in evidence collection (e.g., in tape lifts of fingerprints). Tape samples may adhere to themselves during analysis, sealing in DNA or other biochemicals that are useful for forensic analysis. Tape samples are inherently sticky and prone to collect contaminants during routine sample processing. Tape samples also commonly roll, fold, or warp upon the addition of solvents or DNA extraction reagents, thus complicating the analysis process.

U.S. 2016/0047720 (Wolgast et al.) describes the use of a thin film and method for collecting a sample that includes a biological analyte that may be attached to a flexible backing for print on adhesive analysis. The film described therein reversibly adheres to a biological sample and solubilizes upon exposure to reagents for the extraction of biological analytes, thus deteriorating the original sample print.

U.S. 2015/0225783 (Mears et al.) describes a system and method for using specialized equipment to utilize the diffused reflection of light to identify a latent print on an object. Mears et al. also describes the use of a nucleic acid analyzer which can process a print and determine the DNA content of the print.

### SUMMARY OF THE DISCLOSURE

In one aspect, a method is provided for recovering a sample of DNA. The method comprises providing a portion of adhesive tape having first and second opposing major surfaces, wherein said first major surface has an adhesive disposed thereon; applying a backing strip to the second major surface of the tape, thereby obtaining a mounted tape, wherein said backing strip has first and second opposing major surfaces, and wherein said first and second major surfaces of said backing strip are embossed; capturing a fingerprint on the first surface of the mounted tape, thereby obtaining a specimen, wherein said specimen contains DNA; winding the specimen into a helical configuration in which opposing surfaces of the adhesive tape are spaced apart from each other by said backing strip, thereby obtaining a wound specimen; placing the wound specimen in a receptacle; and extracting a sample of DNA from the wound specimen with a liquid medium.

In another aspect, a method is provided for visualizing latent fingerprints. The method comprises providing a portion of tape having first and second opposing major surfaces, wherein said first major surface has a latent fingerprint disposed thereon; applying a backing strip to the second major surface of the tape, thereby obtaining a mounted tape, wherein said backing strip maintains said first major surface of said portion of tape in a flattened state; applying a fluorescent dye to the latent fingerprint; and illuminating the first major surface with a radiation source which causes said fluorescent dye to undergo fluorescence characterized by a first emission spectrum having at least one emission band.

In some instances of the foregoing aspect, the latent fingerprints may further contain DNA, and the DNA may be subjected to analysis using fluorescent probes. The fluorescent dye selected for fingerprint visualization preferably does not interfere with the DNA analysis using fluorescent probes. For example, the fluorescent probes may be characterized by a second emissions spectrum having at least one emission band, wherein the at least one emission band in the second emission spectrum does not substantially overlap the at least one emission band in the first emission spectrum.

The backing strip technology disclosed herein supports image capture or visualization of adhesive surfaces by adhering to a sample and holding it flat. This is especially advantageous for previously rolled or folded tape samples that would otherwise not remain flat during the imaging process. The imaging process typically utilizes fluorescent dyes to visualize latent fingerprints. These fluorescent dyes are preferably chosen to ensure that background fluorescence from the visualization dye does not interfere in subsequent DNA analysis, the latter of which is commonly performed using a set of fluorescent probes.

In another aspect, a method is provided for recovering a biological material from a flexible substrate. The method comprises attaching the flexible substrate to a backing material, thereby obtaining a mounted sample, wherein the mounted sample is transformable from a first expanded state to a second state in which at least two portions of the flexible substrate are separated from each other in a spaced-apart relationship by a portion of the backing material; transforming the mounted sample to the second state; and extracting a portion of the biological materials from the mounted sample while the mounted sample is in the second state.

In still another aspect, an article is provided which comprises a backing material; and a flexible substrate which is attached to said backing material and which contains a forensic sample; wherein the backing material and flexible substrate form a composite which is transformable from a first expanded state to a second state in which at least two portions of the flexible substrate are separated from each other in a spaced-apart relationship by a portion of the backing material.

### BRIEF DESCRIPTION OF THE DRAWINGS

FIG. 1 is a diagram of a first particular, non-limiting embodiment of a methodology for the non-destructive identification of latent print and DNA deposited on adhesive materials.

FIG. 2 is a diagram of a second particular, non-limiting embodiment of a methodology for the non-destructive identification of latent print and DNA deposited on adhesive materials.

FIG. 3 is an illustration of an alternative embodiment of the backing strip which has protrusions on a single surface thereof, and which is shown in an expanded state.

FIG. 4 is an illustration of the embodiment of FIG. 3 shown in a compact state.

### DETAILED DESCRIPTION

A technique, termed Tape Analysis For Forensic Identification (TAFFI), is disclosed herein which offers a paradigm shift for forensic laboratories as they analyze challenging types of casework evidence. TAFFI has the potential to improve the analysis and preservation of adhesive samples by allowing both latent print and DNA analysis methods to be performed on the same piece of evidence (i.e., a tape sample) without adversely affecting the physical evidence captured with each method. Consequently, no evidence triage/prioritization is needed to choose between collection of one set of evidence over the other (for example, LP but no DNA vs. DNA but no LP).

The backing strip technology disclosed herein supports image capture or visualization of adhesive surfaces by adhering to a sample and holding it flat. This is especially advantageous for previously rolled or folded tape samples that would otherwise not remain flat during the imaging process. The imaging process typically utilizes fluorescent dyes to visualize latent fingerprints. These fluorescent dyes are preferably chosen to ensure that background fluorescence from the visualization dye does not interfere in subsequent DNA analysis, the latter of which is commonly performed using a set of fluorescent probes.

During DNA extraction, the backing strip rolls up to minimize the volume of extraction fluids required, while maximizing the surface area of tape presented for DNA extraction. This process may also be utilized in the extraction of other forensically relevant biochemicals (by way of example but not limitation, these biochemicals may include proteins, metabolites, RNA or microbial DNA) from tape samples. Maximizing the ratio of surface area to volume improves the yield of biological materials from the sample, which is frequently critical for the analysis of trace materials.

Preferred embodiments of the systems, methodologies and devices disclosed herein offer several advantages over their counterparts in the prior art. These may include: 1) the use of a flexible, embossed backing strip that affixes to the non-adhesive side of a tape sample to hold the sample flat during latent fingerprint analysis; 2) the use of a fluorescent dye for latent fingerprint visualization with an emission wavelength that falls outside those wavelengths used in quantification and amplification kits for DNA analysis, effectively overcoming interference with DNA analysis, 3) the process of compactly rolling and submerging the tape/backing strip unit in buffer, thus allowing full access of the tape surface to enhance DNA extraction efficiency; and 4) the use of a simplified DNA extraction procedure that minimizes DNA loss, removes inhibitors associated with adhesive dissolution, reduces exposure to toxic chemicals, reduces protocol time (which can improve turnaround times for forensic reporting of results) and maximizes DNA quality for capillary electrophoresis (CE) and massively parallel sequencing (MPS) analysis. Taken together, the systems, methodologies and devices disclosed herein have the potential to advance the state-of-the-art in the analysis of adhesives across the spectrum of casework analysis, while also minimizing contamination (due to reduced evidence handling and reagent volumes) and reducing time and skill-level requirements for processing the evidence. The systems, methodologies and devices disclosed herein also reduce or eliminate the exposure of technicians to the toxic chemicals that are frequently used in forensic processes of this type.

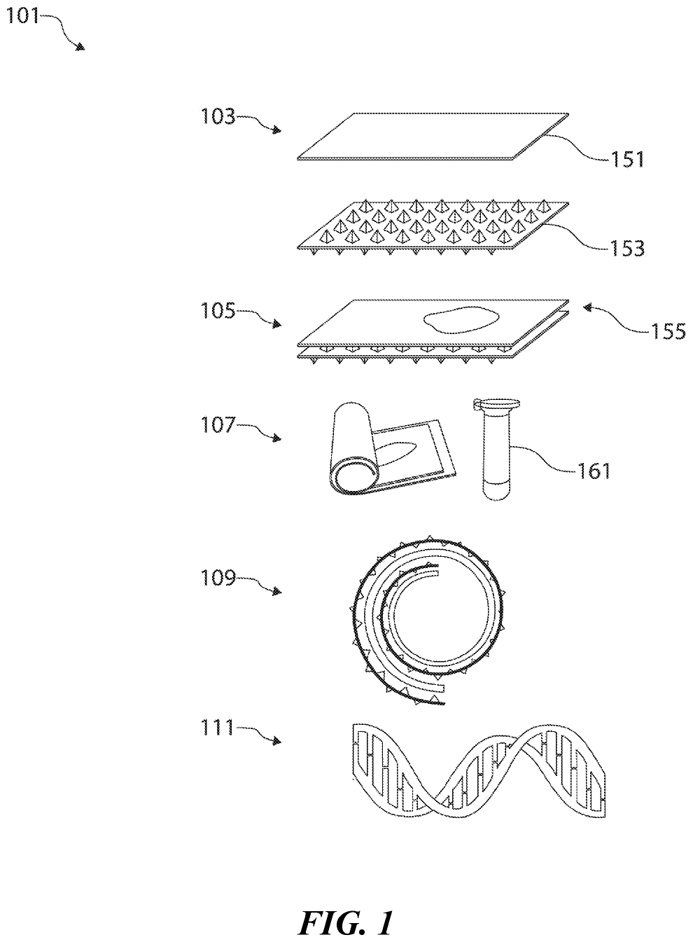

FIG. 1 depicts a first particular, non-limiting embodiment of a methodology 101 in accordance with the teachings herein. With reference thereto, an adhesive tape sample 151 is unrolled and flattened 103, and affixed 105 to a backing strip 153. The backing strip 153 is preferably flexible and preferably comprises a non-reactive material which is preferably capable of binding to either the adhesive or non-adhesive side of the adhesive tape sample 151 (whichever side is not desired for analysis) to form a composite 155.

Various means may be employed to attach the backing strip 153 to the adhesive tape sample 151. Such means may include, for example, the use of non-reactive adhesives, or a set of micro points, needles (shown) or other suitable embossments on the backing strip 153 which would not break through the adhesive tape sample 151 on the opposite side.

A fluorescent dye, which may be in powder, oil or liquid form, may be used to illuminate the print on the opposite side of the backing strip 153. This step enables fingerprint visualization with emission wavelengths that falls outside those wavelengths used in amplification kits for DNA analysis. This approach effectively overcomes current challenges involving detection modes which interfere with DNA analysis.

As previously noted, in a preferred embodiment, the backing strip 153 is flexible and has the ability to adhere to either side of an adhesive tape sample 151. Accordingly, after being attached to the adhesive tape sample 151, the backing strip 153 may be rolled 107 or otherwise assembled into a compact structure 109 (for example, one which readily fits into standard 2 mL microcentrifuge tubes). This compact structure 109 provides an increased surface area to volume ratio, which allows for effective and efficient DNA analysis without disturbing the non-adhesive facing surface of the evidentiary adhesive tape sample 151. Preferably, the compact structure 109 is a helical winding, and even more preferably, a helical winding in which opposing surfaces of the adhesive tape sample 151 are separated by the backing strip 153. One or both surfaces of the backing strip 153 may be embossed or otherwise provided with surface features or protrusions which maintain opposing surfaces of the adhesive tape sample 151 in a spaced-apart relationship with respect to each other, and preferably, with respect to one or both major surfaces of the backing strip 153.

The compact structure 109 achieved after rolling 107 the composite structure also reduces the amount of reagents required to analyze a tape sample. Thus, for example, traditional analytic techniques (e.g., Qiagen DNA Investigator) may use 0.5 mL to 5 mL of DNA extraction solution to process a 1-inch square section of tape. By contrast, use of the backing strip disclosed herein is typically found to decrease required reagent volumes to within the range of 0.05 mL to 0.5 mL.

The foregoing approach is a simplified method for DNA extraction which includes rolling up the tape sample and attached backing strip and placing the composite structure into a microcentrifuge tube 161 or spin basket device. This approach is found to reduce reagent volumes by up to 50-90% compared to conventional techniques, reduces tape handling, and reduces contamination risks, time expenditure and exposure to toxic chemicals.

The DNA, RNA, or protein products 111 obtained by this process may be used in various subsequent analytical or forensic processes. For example, these products 111 may be utilized for short tandem repeat (STR) analysis via capillary electrophoresis or DNA sequencing methods, single nucleotide polymorphism (SNP) analysis via DNA sequencing or PCR analysis, RNA sequence analysis via cDNA sequencing, and/or protein sequence analysis via mass spectrometry.

In a preferred embodiment of the systems, methodologies and devices disclosed herein, the backing strip disclosed herein includes a substrate consisting of a thin, flexible strip. This strip may comprise various metals, polymeric materials, silicones or other suitable compositions. For example, in some embodiments, the backing strip may comprise a foil tape (preferably comprising aluminum or stainless steel) that may be embossed. Such embossment may occur either during tape manufacturing or during backing strip production. The strip preferably has sufficient rigidity when flat to allow it to hold a previously folded section of tape in a flat orientation for fingerprint visualization. When rolled, the backing strip preferably forms a tight spiral with the width between layers primarily defined by a set of spikes, embossments, or protrusions that permit fluid movement between layers. These protrusions are preferably <1 mm in height, it being understood that the exact dimensions of such protrusions or embossments may be dictated by various considerations such as, for example, desired flow rates or permeabilities of analytical reagents with respect to the rolled up structure. A thin layer of adhesive may be applied to the backing strip to permit attachment of the tape sample. The adhesive layer may comprise a thin, double-sided adhesive or layer of glue applied to the backing strip, and is preferably protected prior to use by a disposable, removable backing.

A fluorescent dye may be utilized to detect and analyze latent fingerprints. The fluorescent dye may include, but is not limited to, Coumarin-1, Coumarin-314, Rhodamine 6G, 9,10-diphenylanthracene, and fluorescently labeled variants of Genipin, Rhodamine 800, and Ninhydrin.

Once the latent fingerprints have been analyzed, the backing strip 153 is rolled by manually engaging the microneedles or embossments on the backside of the backing strip 153, which will not irreversibly affect the integrity of the adhesive tape sample 151. The backing strip 153 may be modified as necessary to fit into multiple sizes or shapes of microcentrifuge tubes.

Utilization of the backing strip 153 may involve the removal of any protective paper, liner or foil to reveal the adhesive strip. Tape samples may then be affixed (preferably gently and/or releasably) to the adhesive layer. Visualization of latent fingerprints may proceed at this step, preferably by cyanoacrylate fuming and application of a fluorescent dye. Next, the backing strip 153 may be rolled tightly to produce a cylindrical insert which may be added to a spin basket device and placed into a microcentrifuge tube. DNA extraction reagents are added to the sample prior to a brief incubation step. The extraction liquid is collected into the microcentrifuge tube via a brief centrifugation step. DNA, protein, or other biochemicals are then purified from the eluate using commercial DNA purification kits or similar commercial purification reagents for associated biochemicals. Purified DNA will then undergo quantification prior to sequence analysis.

The backing strip 153 may comprise various materials. These may include, without limitation, various metallic strips, thin plastic or polymeric strips, fabric strips, releasable fastener strips (such as those sold under the tradename Velcro®) coated with adhesive on the fabric surface, silicone, waxes or hydrophobic polymer coated papers.

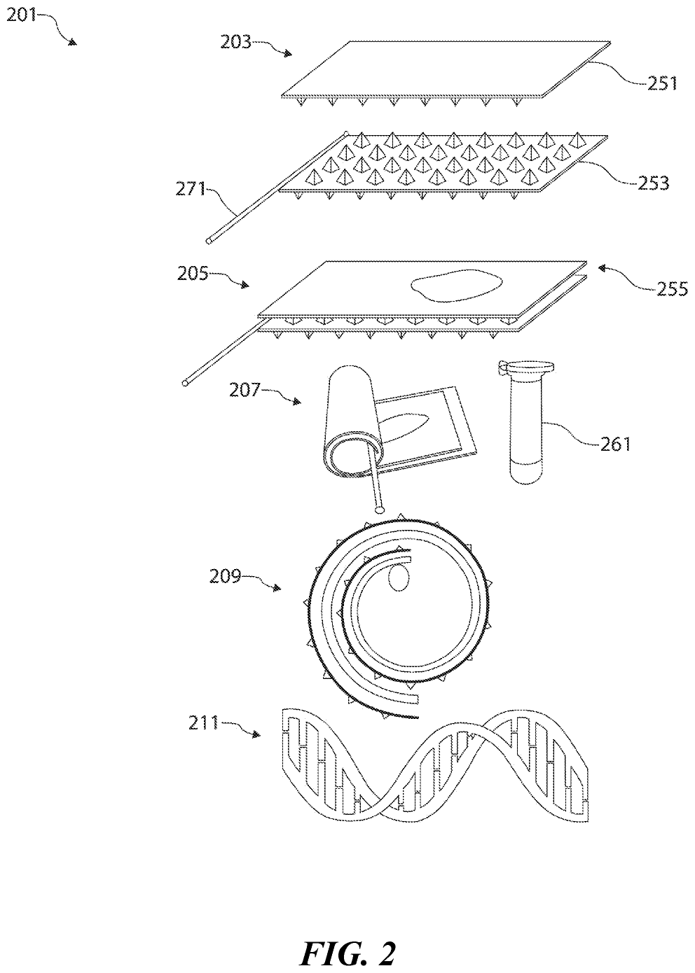

FIG. 2 depicts a second particular, non-limiting embodiment of a methodology 202 in accordance with the teachings herein. This methodology is similar in most respects to the methodology of FIG. 1. However, in this embodiment, the backing strip 253 is rolled 207 or otherwise assembled into a compact structure 209 through the use of a spindle 271. The spindle 271 facilitates rolling the backing strip 253 into a compact structure 209, while also minimizing the handling of the backing strip during this process. It will thus be appreciated that, in some applications, the use of the spindle 271 may reduce or minimize contamination of the backing strip 253 or adhesive tape sample 251 mounted thereon. The use of the spindle 271 may also allow the backing strip 253 to be rolled into the tightest configuration possible, thereby minimizing the volume of the microcentrifuge tube 261 or spin basket device and the quantities of chemicals required to process the adhesive tape sample 251.

It will be appreciated that the spindle may assume various geometries, configurations and dimensions. Preferably, the spindle 271 is a cylindrical element which is approximately twice the width of the backing strip 253 in length, although longer or shorter lengths may be utilized in various applications. The spindle 271 is preferably of sufficient length to allow handling and manipulation of the backing strip 253 without requiring the user to touch or come into contact with the backing strip 253. In some embodiments, the spindle 271 may be thicker in the portion handled by the user, or may be equipped with a handle, to facilitate the manipulation thereof.

The spindle 271 may be attached to the backing strip 253 in various ways. In some embodiments, the spindle 271 may be mechanically attached to the adhesive tape sample 251, the backing strip 253 and/or composite 255. In such embodiments, for example, the spindle 271 may be equipped with a longitudinal slit which engages an edge or corner of the adhesive tape sample 251, the backing strip 253 and/or composite 255. One or more of the adhesive tape 251 sample, the backing strip 253 and/or composite 255 may also be equipped with a sleeve, indentation, protrusion, or other suitable feature that mechanically engages the spindle 271 for this purpose.

In other embodiments, a suitable adhesive may be utilized to adhere the spindle 271 to the adhesive tape 251 sample, the backing strip 253 and/or composite 255. Preferably, the adhesive chosen for this purpose is selected to avoid interference with, or degradation of, the adhesive tape 251 sample or the analysis thereof, and thus is preferably selected to be inert to, or insoluble in, any solvents or chemicals utilized for that purpose.

The spindle 271 is preferably attached asymmetrically to the adhesive tape sample 251, the backing strip 253 and/or composite 255. In particular, the spindle 271 is preferably attached to the adhesive tape sample 251, the backing strip 253 and/or composite 255 such that only one end of the spindle 271 protrudes therefrom. In many applications, such a disposition of the spindle 271 will be advantageous in that, for example, it minimizes the size of the microcentrifuge tube 261 or spin basket device required to accommodate it, which may in turn minimize the volume of the solvents or chemicals utilized to treat or analyze the adhesive tape sample 251. However, embodiments are also possible which utilize a symmetrical disposition of the spindle 271.

The spindle 271 may comprise various materials including, for example, wood, plastics or metals, and may be treated with various coatings or finishes. Preferably, the spindle 271 is impervious to, and nonreactive with, the chemicals or solvents commonly utilized in treating or analyzing adhesive tape samples for forensic purposes.

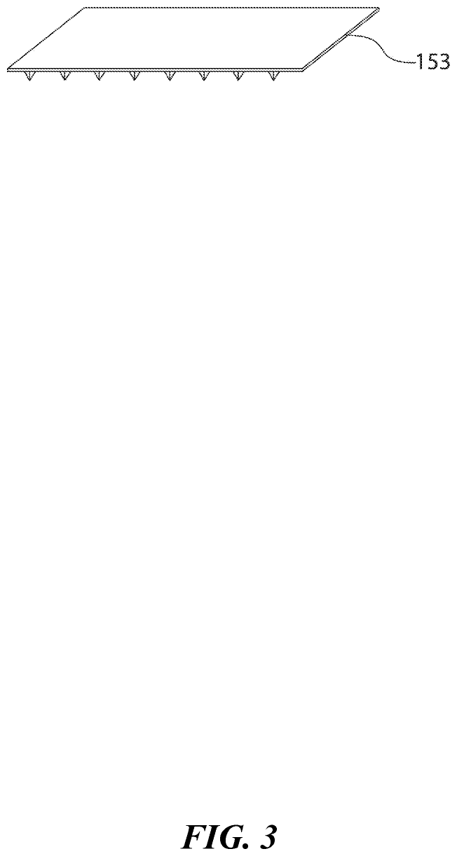

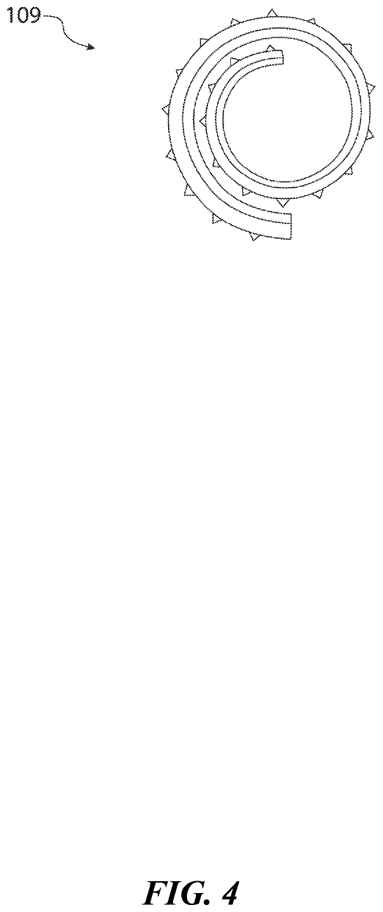

The use of embossed backing strips 153 (see FIG. 1) is preferred in the systems and methodologies disclosed herein. Such embossments may include one or more protrusions (which may include, for example, spikes, pins, ridges, or the like), and preferably include a plurality of protrusions which improve the flow of fluid between adjacent layers of tape. However, in some embodiments, a non-embossed, fluid permeable backing strip 153 may be utilized to similar effect. While it is preferred that both surfaces of the backing strip 153 are embossed as shown in FIG. 1, as shown in FIG. 3, embodiments are also possible in which only one surface of the backing strip 353 is embossed. As with the previous embodiment, this backing strip 153 may also be wound into a compact structure 409 as shown in FIG. 4.

Various fluorochromes or fluorescently tagged dyes may be utilized in the systems and methodologies disclosed herein. These include, without limitation, Stilbene 420 and fluorescently labeled Ninhydrin. These also may include fluorochromes that overlap typical commercially available DNA analysis methods, although it is preferred that the DNA extraction method sufficiently removes this compound prior to DNA analysis.

Various techniques may be utilized for fingerprint visualization in the systems and methodologies disclosed herein. These include, without limitation, non-fluorescent methods such as fingerprint dust, Wet Wop, and the like.

In some embodiments of the systems and methodologies disclosed herein, larger backing strips may be used to accommodate larger tape samples (typically >3″), such as, for example, duct tape. Larger volume tubes such as 15 mL or 50 mL conical tubes may be utilized to process these samples.

In some embodiments of the systems and methodologies disclosed herein, a backing strip with embossments on both sides may be utilized to permit simultaneous DNA extraction from both sides of the tape sample. Such a backing strip may be rolled up for insertion into a collection tube in a similar manner to other embodiments of the backing strip disclosed herein.

Various extraction reagents or chemistries may be utilized for extraction in conjunction with the backing strips disclosed herein. In addition to those described above, any various suitable collection or lysis buffers in commercial DNA, RNA, or protein preparation kits may be utilized for analysis with the backing strips disclosed herein.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A method for recovering a biological material from a flexible substrate, comprising:
attaching the flexible substrate to a backing material, thereby obtaining a mounted sample, wherein the mounted sample is transformable from a first expanded state to a second state in which at least two portions of the flexible substrate are separated from each other in a spaced-apart relationship by a portion of the backing material;
transforming the mounted sample to the second state; and
extracting a portion of the biological materials from the mounted sample while the mounted sample is in the second state.

2. The method of claim 1, wherein the flexible substrate is a portion of adhesive tape.

3. The method of claim 1, wherein transforming the mounted sample to the second state includes winding the mounted sample into a helical structure.

4. The method of claim 1, wherein said backing and said substrate have first and second opposing surfaces, wherein said first surface of said backing material attaches to a first surface of said flexible substrate, and wherein said second surface of said backing material releasably engages said second surface of said flexible substrate.

5. The method of claim 4, wherein said second surface of said backing material is equipped with at least one protrusion.

6. The method of claim 4, wherein said second surface of said backing material is equipped with a plurality of protrusions.

7. The method of claim 4, wherein said first and second surfaces of said backing material are equipped with a plurality of protrusions.

8. The method of claim 1, wherein extracting a portion of the biological materials from the mounted sample includes placing the mounted sample in a receptacle, and passing a solvent across at least a portion of at least one surface of the flexible substrate while the mounted sample is in the receptacle.

9. The method of claim 1, further comprising:
attaching a spindle to at least one of the backing material and the flexible substrate.

10. A method for recovering a sample of DNA, comprising:
providing a portion of adhesive tape having first and second opposing major surfaces, wherein said first major surface has an adhesive disposed thereon;
applying a backing strip to the second major surface of the tape, thereby obtaining a mounted tape, wherein said backing strip has first and second opposing major surfaces, and wherein said first and second major surfaces of said backing strip are embossed;
capturing a fingerprint on the first surface of the mounted tape, thereby obtaining a specimen, wherein said specimen contains DNA;
winding the specimen into a helical configuration in which opposing surfaces of the adhesive tape are spaced apart from each other by said backing strip, thereby obtaining a wound specimen;
placing the wound specimen in a receptacle; and
extracting a sample of DNA from the wound specimen with a solvent.

11. The method of claim 10, further comprising:
winding the specimen into a helical configuration in which opposing surfaces of the adhesive tape are spaced apart from each other by said backing strip, thereby obtaining a wound specimen.

12. The method of claim 10, wherein a spindle is attached to an edge of the backing tape or mounted tape, and wherein winding the specimen into a helical configuration includes rotating the spindle about its longitudinal axis.

13. An article, comprising:
a backing material; and
a flexible substrate which is attached to said backing material and which contains a forensic sample;
wherein the backing material and flexible substrate form a composite which is transformable from a first expanded state to a second state in which at least two portions of the flexible substrate are separated from each other in a spaced-apart relationship by a portion of the backing material.

14. The article of claim 13, wherein the flexible substrate is a portion of adhesive tape.

15. The article of claim 13, wherein transforming the mounted sample to the second state includes winding the mounted sample into a helical structure.

16. The article of claim 13, wherein said backing and said substrate have first and second opposing surfaces, wherein said first surface of said backing material attaches to a first surface of said flexible substrate, and wherein said second surface of said backing material releasably engages said second surface of said flexible substrate.

17. The article of claim 16, wherein said second surface of said backing material is equipped with at least one protrusion.

18. The article of claim 16, wherein said second surface of said backing material is equipped with a plurality of protrusions.

19. The article of claim 16, wherein said first and second surfaces of said backing material are equipped with a plurality of protrusions.

20. The article of claim 12, further comprising:
a spindle attached to at least one of the backing material and the flexible substrate.
